(19) United States
(12) Patent Application Publication
(10) Pub. No.: US 2011/0250861 A1
(43) Pub. Date: Oct. 13, 2011

(54) HIGHLY INTEGRATED, HIGH FREQUENCY, HIGH POWER OPERATION MMIC

(75) Inventors: Michael R. Lyons, Gilbert, AZ (US); Kenneth V. Buer, Gilbert, AZ (US); Dean Lawrence Cook, Mesa, AZ (US); Christopher D. Grondahl, Gilbert, AZ (US)

(73) Assignee: VIASAT, INC., Carlsbad, CA (US)

(21) Appl. No.: 12/756,964

(22) Filed: Apr. 8, 2010

(51) Int. Cl. H04B 1/26

(52) U.S. Cl. 455/326

(57) ABSTRACT

A system and method for high frequency, high power operation communication systems is provided. More particularly, a system and method for a single system-on-chip system monolithic microwave integrated circuit that provides both high-frequency performance at a low cost is provided.

### FIELD OF INVENTION

A system and method for high frequency, high power operation communication systems is provided. More particularly, a system and method for a single system-on-chip monolithic microwave integrated circuit (MMIC) that provides both high frequency performance at a low cost is provided.

### BACKGROUND OF THE INVENTION

The telecommunication industry's current manufacturing methods for high frequency, high-power devices lend themselves to focusing on either high frequency performance or a low cost solution, normally favoring one or the other. Conventional approaches utilize multiple components which may be individually optimized and generally housed on separate chips.

For instance, currently one can piece together an up-converter system by selecting off the shelf devices such as a high linearity mixer combined with an off-chip PCB filter on a low loss substrate coupled with a driver amplifier with a pre-selected amount of gain and overhead to drive a high-power amplifier. When these multi-chip components are connected, chip-to-chip interface losses generally degrade system performance. For instance, known mismatch issues for multi-chip approaches include reducing the standing wave ratio (VSWR) which generally may cause additional unwanted ripple in a system. Also, though the individual components may be optimized for their specific high frequency function, the fully connected system is not optimized.

Additionally, a high frequency gain feedback potential (tending towards oscillation) exists when coupling multiple components housed on individual chips. Generally, with multiple components housed on individual chips, in a typical transmit chain the overall RF gain required is high due to potential early stage or mixer compression. The typical solution is to provide many stages of RF gain (e.g. greater than 8 or more) which previously contributed to making a single chip solution impractical.

With reference to FIG. 1, in a typical design depicting a single chip amplifier design with an input and an output at the same frequencies, especially at K, Ka or higher frequency bands of operation, the gain required is high enough for MMIC chip reverse isolation issues to be of concern. For instance, with renewed reference to FIG. 1, wirebond-to-wirebond, cavity molding or other discontinuities may result in radiated energy being transmitted from the MMIC output back to the input. Typical ways to reduce this effect are physically spacing out multiple MMIC die, channelizing or shielding and/or using frequency absorbing materials (e.g. Eccosorb or equivalent). Also, multiple lower-gain MMICs may be selected to reduce this effect, but the size, cost and complexity also increases with these approaches. Also, multi-chip modules (MCMs) that are configured within a single package may be implemented on more than one chip and/or die, however, these utilize wirebonds and/or ribbon-bonds.

Multiple components housed on individual chips may also increase the size and the cost of the system and devices. Also, coupling multiple components housed on individual chips is not efficient for mass production. Also, designing each piece separately and then cascading all parts in a system suffers from the additional manufacturing variation due to chip-to-chip interconnects via wirebond/ribbon-bond and or substrate connections. For instance, manufacturing process sensitivities, such as multiple MMIC die attach locations, positioning of RF interfaces, as well as PWB placement control, are generally not considerations for optimization on multi-chip systems.

Accordingly, there exists a need for a single system-on-chip monolithic microwave integrated circuit that provides both high-frequency performance at a low cost.

### SUMMARY OF THE INVENTION

In one exemplary embodiment, the system includes: a high-linear mixer, wherein the high-linear mixer is configured to accept a local oscillator signal and an intermediate frequency signal; a first driver amplifier; a multi-stage filter; a second driver amplifier; and a high powered output amplifier. In one exemplary embodiment, the high-linear mixer, first driver amplifier, multi-stage filter, second driver amplifier, and high powered output amplifier are fabricated as single system-on-chip up-converter monolithic microwave integrated circuit.

In one exemplary embodiment, the system includes: a high-linear mixer, wherein the high-linear mixer is configured to accept a local oscillator signal and an intermediate frequency signal; a first driver amplifier; a multi-stage filter; a second driver amplifier; and a high powered output amplifier. In this exemplary embodiment, there is no wirebond between one or more of: the high-linear mixer, the first driver amplifier; the multi-stage filter; the second driver amplifier; and the high powered output amplifier.

In one exemplary embodiment, a method includes: (1) combining a local oscillator signal with an intermediate frequency signal in a high-linear mixer; (2) outputting a first signal from the high-linear mixer to a first driver amplifier; (3) amplifying the output of the high-linear mixer; (4) filtering the output of the first driver amplifier, wherein the filtering is performed by a filter; (5) outputting a second signal of the filter to a second driver amplifier; (6) amplifying the output of the filter; (7) outputting a third signal from the second driver amplifier to a high powered output amplifier; and (8) amplifying the third signal from the second driver amplifier. In this exemplary embodiment, the high-linear mixer, first driver amplifier, multi-stage filter, second driver amplifier, and high powered output amplifier further comprise a single system-on-chip up-converter monolithic microwave integrated circuit.

### BRIEF DESCRIPTION OF THE DRAWINGS

These and other features, aspects and advantages of the present invention will become better understood with reference to the following description, appending claims, and accompanying drawings where:

FIG. 1 illustrates, in block format, an embodiment of reverse isolation feedback in accordance with prior art embodiments;

FIG. 2 illustrates, in block format, components of a single system-on-chip monolithic microwave integrated circuit in accordance with one exemplary embodiment of the invention;

FIG. 3 illustrates a FET ring mixer in accordance with various exemplary embodiments of the invention;

FIG. 4A illustrates a schematic diagram of an exemplary capacitively loaded single-resonator spurline filter;

FIG. 4B illustrates a schematic diagram of an exemplary capacitively loaded dual-resonator spurline filter; and

FIG. 5 illustrates an exemplary topology of a multi-stage amplifier in accordance with various exemplary embodiments of the invention.

### DETAILED DESCRIPTION

While exemplary embodiments are described herein in sufficient detail to enable those skilled in the art to practice the invention, it should be understood that other embodiments may be realized and that logical material, electrical, and mechanical changes may be made without departing from the spirit and scope of the invention. Thus, the following detailed description is presented for purposes of illustration only.

In one exemplary embodiment, a high frequency, high power up-converter with optimized performance fabricated as a single integrated MMIC is disclosed. In one exemplary embodiment, a high linear mixer, a filter, and at least one amplifier, such as a multi-stage amplifier and/or multi-stage high powered amplifier are mounted on a single integrated circuit. In this embodiment, the high linear mixer is configured to accept an IF signal and a LO signal.

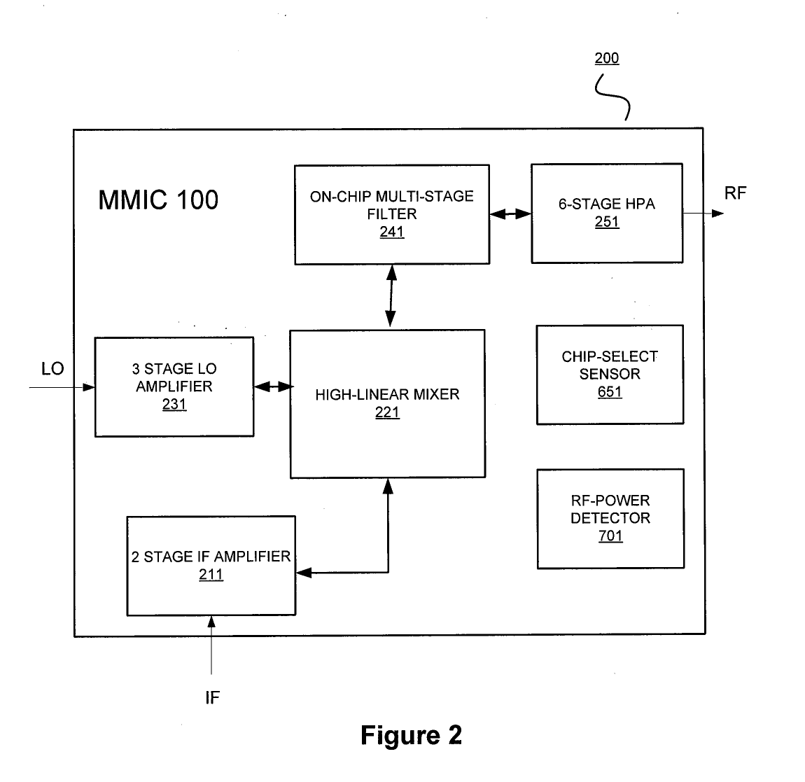

In accordance with an exemplary embodiment, and with reference to FIG. 2, system 200 incorporates a high frequency, high power communication device (e.g. an up-converter) with optimized performance into a single integrated circuit, such as a single monolithic microwave integrated circuit 100. In one exemplary embodiment, system 200 comprises a high-linear mixer 221, a filter 241, and a high power amplifier 251. In another exemplary embodiment, system 200 further comprises a chip select sensor 651, a driver amplifier and/or an RF power detector 701.

In one exemplary embodiment, the output of high linear mixer 221 may be connected to the input of a filter, such as the input of multi-stage filter 241. In this exemplary embodiment, multi-stage filter 241 may be coupled to the input of an amplifier, such as high power six-stage amplifier 251. Furthermore, system 200 may additionally comprise various driver amplifiers that are interposed in series. For example, before and/or after high-linear mixer 221.

In an exemplary embodiment, system 200 incorporates an amplifier 211, which may be located off-chip or which may be integrally coupled to MMIC 100. In an exemplary embodiment, the input of amplifier 211 is in signal communication with an IF signal input for system 200 and the output of amplifier 211 is in signal communication with the input of high-linear mixer 221. In an exemplary embodiment, system 200 incorporates an amplifier 231, which may be located off-chip or which may be integrally coupled to MMIC 100. In an exemplary embodiment, the input of amplifier 231 is in signal communication with an LO signal input for system 200 and the output of amplifier 231 is in signal communication with the input of high-linear mixer 221. Furthermore, the input of a driver amplifier is in signal communication with the output of high-linear mixer 221 and in signal communication with the input of filter 241. Additionally, the input of high power amplifier 251 is in signal communication with the output of filter 241 and the output of high power amplifier 251 is in signal communication with an RF signal output of system 200.

In an exemplary embodiment, two or more of components of system 200 are on the same chip. For example, two or more of high-linear mixer 221, amplifiers (211/231), driver amplifiers, filter 241, and high power amplifier 251 may be located on the same chip. For example, an IF amplifier, such as 2-stage IF amplifier 211, may be integrally coupled to system 200, such as integrally coupled to MMIC 100. As another example, an LO amplifier, such as 3-stage LO amplifier 231, may be integrally coupled to system 200, such as integrally coupled to MMIC 100. In one exemplary embodiment, amplifier 211 is a 2-Stage IF Amplifier. Amplifiers 211, and 231 may increase the power of the IF and LO signals respectively.

In another exemplary embodiment, chip-select sensor 651 may be integrally coupled to system 200, such as integrally coupled to MMIC 100. In another exemplary embodiment, RF-power detector 701 may be integrally coupled to system 200, such as integrally coupled to MMIC 100. In one exemplary embodiment, there are no wirebonds and/or “ribbon-bonds” between one or more of high-linear mixer 221, driver amplifier, multi-stage filter 241, and high powered output amplifier 251.

In one exemplary embodiment, system 200 may be fabricated on any suitable MMIC substrate (i.e., chip, die) of a suitable semiconductor material such as silicon (Si), gallium arsenide (GaAs), silicon germanium (SiGe), germanium (Ge), indium phosphide (InP), and combinations, such as mixed silicon and germanium, mixed silicon and carbon, and the like. In one exemplary embodiment, system 200 operates at a frequency in one of the X, K, Ka, Ku, V, Q, U, E, F, D, and/or W bands.

In one exemplary embodiment, system 200 may be designed as a stand-alone design, the performance of each element can be optimized as a system to take advantage of the single-chip design architecture. For instance, a single simulation tool which simulates all elements to be fabricated on a single chip can be performed. The performance of each section and each element can be optimized individually and/or in relation to other system 200 component elements to configure a system 200 for desired performance.

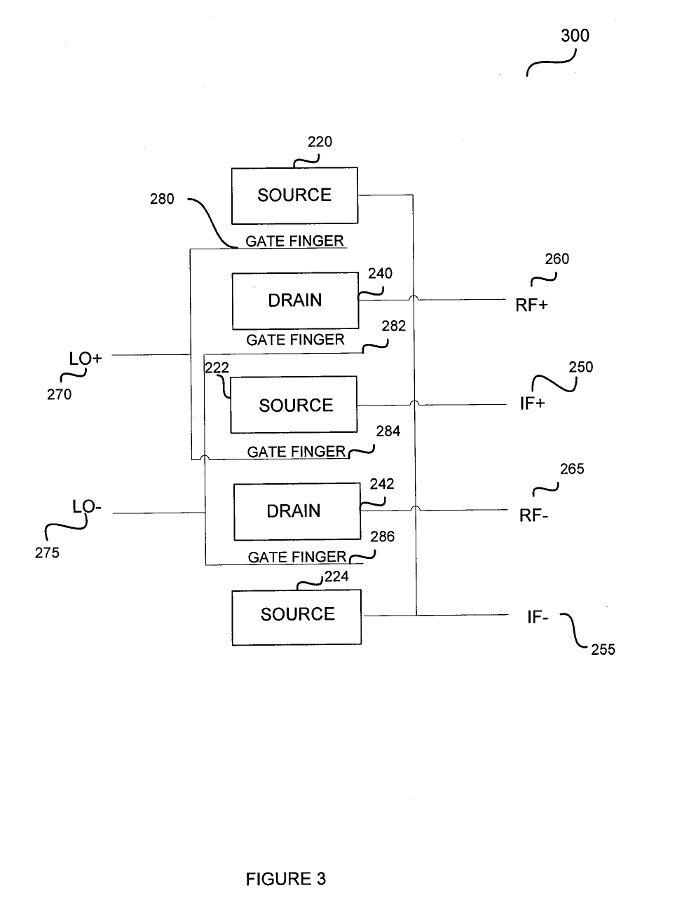

In one exemplary embodiment with reference to FIG. 3, though any suitable mixer(s) may be utilized, the high-linear mixer 221 of system 200 comprises a highly-compact, highly linear and high compression mixer 300. In one exemplary embodiment, this highly-compact, highly linear and high compression mixer 300 may facilitate reduced RF gain after mixer 300. In one exemplary embodiment, mixer 300 may facilitate maintaining spurious signal compliance.

In an exemplary embodiment and with reference to FIG. 3, the MMIC based FET resistive mixer 300 includes a plurality of three terminal semiconductor portions on a single substrate. In one exemplary embodiment, the three terminal semiconductor portions, may be configured as bipolar junction transistors (BJTs). The three terminal semiconductor portions, in one exemplary embodiment, may be configured as field effect transistors (FETs). In this exemplary embodiment, the FETs may include a source terminal, a drain terminal and a gate terminal. The three terminal semiconductor portions may be built upon a MMIC substrate. In an exemplary embodiment, at least one of the source terminal, drain terminal and gate terminal may be coupled to at least one input of a LO+ signal, a LO− signal, an IF+ signal, an IF− signal, a RF+ signal, and a RF− signal. In one exemplary embodiment, as shown in FIG. 3, at least one of the source terminal, drain terminal, and gate terminal of the plurality of FETs may be directly coupled to at least one input of the IF+ signal, RF+ signal, and RF− signal with a reduction of previously required interconnects, and thus a reduction of interconnect line lengths, between the plurality of FETs.

In an exemplary embodiment, MMIC based FET resistive mixer 300 has six signal input terminals. In an exemplary embodiment, referring to FIG. 3, at least one LO+ signal input 270 is coupled to a first subset (e.g. 280, 284) of the plurality of gate terminals (e.g. 280, 282, 284, 286). In an exemplary embodiment, a LO− 275 signal input is coupled to a second subset (e.g. 282, 286) of the plurality of gate terminals (e.g. 280, 282, 284, 286). In an exemplary embodiment, a RF+ 260 signal input is coupled to a first subset (e.g. 240) of the plurality of drain terminals (e.g. 240, 242). In an exemplary embodiment, a RF− 265 signal input is coupled to a second subset (e.g. 242) of the plurality of drain terminals (e.g. 240, 242). In an exemplary embodiment, an IF− 255 signal input is coupled to a first subset (e.g. 220, 224) of the plurality of source terminals (e.g. 220, 222, 224). In an exemplary embodiment, an IF+ 250 signal input is coupled to a second subset (e.g. 222) of the plurality of source terminals (e.g. 220, 222, 224). In an exemplary embodiment, a first subset (e.g. 220, 224) of a plurality of source terminals (e.g. 220, 222, 224) are coupled together. In an exemplary embodiment, the first subset (e.g. 280, 284) of the plurality of gate terminals (e.g. 280, 282, 284, 286) may be coupled together. In an exemplary embodiment, a second subset (e.g. 282, 286) of the plurality of gate terminals (e.g. 280, 282, 284, 286) are coupled together. In an exemplary embodiment, the first subset 240 of the plurality of drain terminals (e.g. 240, 242) comprise one drain terminal (e.g. 240). In an exemplary embodiment, the second subset 242 of the plurality of drain (e.g. 240, 242) terminals comprises one drain terminal (e.g. 242).

For instance, with reference to FIG. 3, MMIC based FET resistive mixer 300 may include multiple three terminal semiconductor portions housed on a single substrate. In one exemplary embodiment, MMIC based FET resistive mixer 300 may include four three terminal semiconductor portions housed on a single substrate. In an exemplary embodiment, a LO+ signal input 270 is coupled to a first gate terminal 280. In an exemplary embodiment, the first gate terminal 280 may be coupled to a first source terminal 220 and a first drain terminal 240. In an exemplary embodiment, LO+ signal input 270 may be coupled to a third gate terminal 284. In an exemplary embodiment, the third gate terminal 284 may be coupled to a second source terminal 222 and a second drain terminal 242. In an exemplary embodiment, LO− signal input 275 may be coupled to a second gate terminal 282. In an exemplary embodiment, the second gate terminal 282 may be coupled to the first drain terminal 240 and the second source terminal 222. In an exemplary embodiment, LO− signal input 275 may be coupled to a fourth gate terminal 286. In an exemplary embodiment, the fourth gate terminal 286 may be coupled to the second drain terminal 242 and a third source terminal 224. In an exemplary embodiment, RF+ signal input 260 may be coupled to the first drain terminal 240. In an exemplary embodiment, RF− signal input 265 may be coupled to the second drain terminal 242. In an exemplary embodiment, IF− signal input 255 may be coupled to the first source terminal 220 and the third source terminal 224. In an exemplary embodiment, IF+ signal input 250 may be coupled to the second source terminal 222. In an exemplary embodiment, the first source terminal 220 and the third source terminal 224 may be coupled together. In an exemplary embodiment, the first gate terminal 280 and the third gate terminal 284 may be coupled together. In an exemplary embodiment the second gate terminal 282 and the fourth gate terminal 286 may be coupled together.

In one exemplary embodiment, the couplings to the IF− signal input 255 and the IF+ signal input 250 as depicted in mixer 300 of FIG. 3, are reversed. For instance, in one embodiment, IF+ signal input 250 may be coupled to the first source terminal 220 and the third source terminal 224 and an IF− signal input 255 may be coupled to the second source terminal 222. In one exemplary embodiment, the couplings to the RF− signal input 265 and the RF+ signal input 260 as depicted in mixer 300 of FIG. 3, are reversed. For instance, in an exemplary embodiment, RF+ signal input 260 may be coupled to the second drain terminal 242 and RF− signal input 265 may be coupled to the first drain terminal 240. In one exemplary embodiment, the couplings to the LO− signal input 275 and the LO+ signal input 270 as depicted in mixer 300 of FIG. 3, are reversed. For example, in an exemplary embodiment, a LO− signal input 275 is coupled to a first gate terminal 280 and a third gate terminal 284. Also, for example, in an exemplary embodiment, LO+ signal input 270 may be coupled to a second gate terminal 282 a fourth gate terminal 286.

In another exemplary embodiment, IF− signal input 255, RF− signal input 265, and/or LO− signal input 275 are tied to a common ground. In an exemplary embodiment, the system may be configured as single balanced mixer with IF− signal input 255, RF− signal input 265, and LO− signal input 275 fed single ended reducing half of the structure as compared with mixer 300.

In an exemplary embodiment, the LO is housed on the same substrate the MMIC based FET resistive mixer 300 is mounted on (e.g. MMIC 100). In another exemplary embodiment, the LO is not housed on the same substrate the MMIC based FET resistive mixer 300 is mounted on, but a signal from the LO is coupled to the MMIC based FET resistive mixer 300. The LO may be any suitable LO providing any suitable LO frequency.

In another exemplary embodiment, the layout of MMIC based FET resistive mixer 300 is configured such that a high degree of symmetry exists in the RF and LO interconnections. Improved symmetry provides better balance and thus improved spurious performance. By arranging the layout in a way that provides the best symmetry at the highest frequency ports of the mixer, improved high frequency spurious performance is achieved. For example, with reference to FIG. 3, layout of high frequency elements (the RF+ signal input and the RF− signal input) comprise a high level of symmetry. For example, with reference to FIG. 3, layout of the next highest frequency elements (LO+ signal input and LO− signal input) comprise a high level of symmetry. In an exemplary embodiment of MMIC based FET resistive mixer 300, even-order spurious responses are rejected due to the symmetry of MMIC based FET resistive mixer 300.

In an exemplary embodiment, High-linear mixer 300 is configured to accept and combine an intermediate frequency signal (IF) and a local oscillator signal (LO). In an exemplary embodiment, the configuration of MMIC based FET resistive mixer 300 may be substantially free from path length differences. For instance, with renewed reference to FIG. 3, the layout of MMIC based FET resistive mixer 300 may be configured to comprise fewer parasitic interconnect line lengths and other parasitic capacitances and discontinuities that may limit high frequency performance.

Principles of the present disclosure may also suitably be combined with principles for resistive mixers and more particularly, to an improved monolithic microwave integrated circuit (MMIC) FET resistive mixer as disclosed in a co-pending U.S. patent application entitled “Compact High Linearity MMIC Based FET Resistive Mixer” having the same filing date as the present application, the contents of which are hereby incorporated by reference in their entirety.

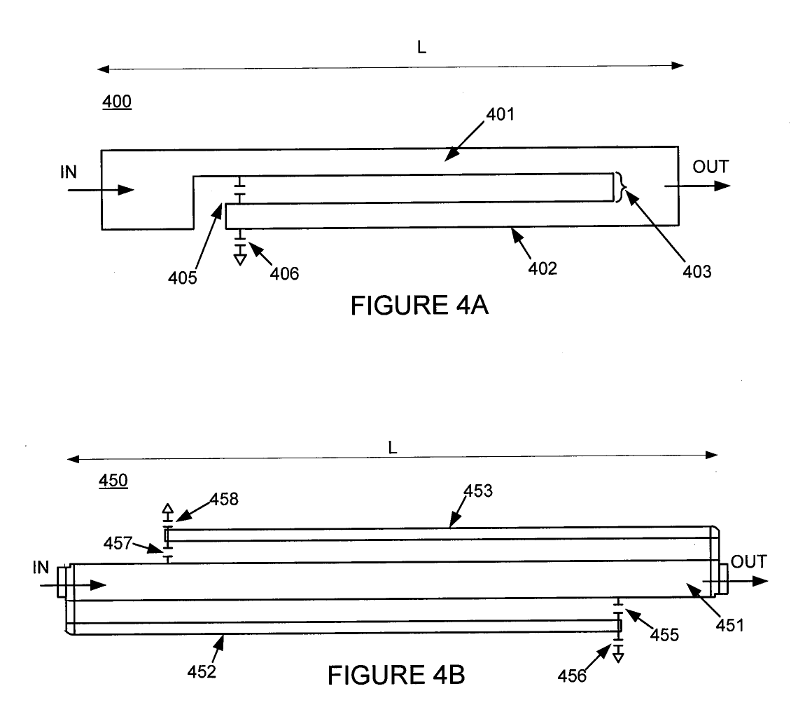

In one exemplary embodiment with reference to FIGS. 4A-4B, though any suitable filter(s) may be utilized, multi-stage filter 241 of system 200 comprises a highly-compact on-chip multistage filter 400, 450 (e.g. a capacitively loaded spurline filter). In one exemplary embodiment, the highly-compact on-chip multistage filter 400, 450 may reduce out-of-band spurious signal levels.

In an exemplary embodiment and with reference to FIGS. 4A and 4B, a single-resonator spurline filter may be viewed as a 360° resonant loop. The length of a conventional single-resonator spur line is a quarter of the signal wavelength (λ/4). An input signal with a normalized phase of 0° travels down the through-line and then back up through the spur. When the signal has reached the open end of the spur, it has traveled λ/2 and has a phase of 180°. The signal at the end of the spur and the input signal are now 180° out of phase, which is conducive to odd-mode coupling. Thus the 360° loop is a combination of the 180° path down the through-line and back up the spur and the 180° odd-mode coupling.

In an exemplary embodiment with renewed reference to FIGS. 4A-4B, the resonance frequency of a spurline filter 400, 450 (single-resonator or dual-resonator, respectively) may be lowered by increasing the odd-mode coupling at the open end of the spur by adding capacitive elements between the open end of the spur and the through-line. In another exemplary embodiment, connecting the open end of the spur with capacitive elements to ground may also be beneficial.

In an exemplary embodiment, the spurline filter 400, 450 comprises capacitive elements. In a further exemplary embodiment, the capacitive elements are configured to reduce the resonant frequency of filter 400, 450. Thus, by designing the capacitive elements to reduce the resonant frequency, the physical length (L) of the filter 400, 450 may be reduced.

In accordance with an exemplary embodiment and with reference to FIG. 4A, spurline filter 400 comprises at least one through-line 401, at least one spur 402, and at least one capacitive element 405, 406. In one exemplary embodiment, the capacitive element may connect the spurline to ground (as shown by 406). In another exemplary embodiment, the capacitive element may connect the spurline 402 to through-line 401 of spurline filter 400 (as shown by 405). In another exemplary embodiment, both capacitive elements 405, 406 are used in spurline filter 400. Stated another way, in an exemplary embodiment, spur 402 is connected to both through-line 401 and ground through respective capacitors.

Furthermore, spurline filter 400 comprises a spurline gap 403 formed by the area between through-line 401 and spur 402. In an exemplary embodiment, at least one of capacitive elements 405, 406 comprises a capacitor, multiple capacitors in series and/or parallel, or other suitable electronic component of capacitive nature as known in the art or hereinafter devised. For example, capacitive elements 405, 406 could be distributed capacitive elements and edge-coupled capacitive elements. In an exemplary embodiment, capacitive elements 405, 406 may be located at, or near, the open end of spur 402. Locating the capacitive elements near the open end of the spur enhances the coupling of the spurline filter, resulting in a physically smaller loop.

In another exemplary embodiment and with reference to FIG. 4B, a dual spurline filter 450 comprises one or more capacitive elements 455, 456. One capacitive element 456 connects a first spur 452 to ground. The other capacitive element 455 connects first spur 452 to a through-line 451 of dual spurline filter 450. Furthermore, in another exemplary embodiment, dual spurline filter 450 further comprises a second spur 453. In one exemplary embodiment, second spur 453 may be in communication with one or more capacitive elements 457, 458. Capacitive element 458 connects second spur 453 to ground. The other capacitive element 457 connects second spur 453 to through-line 451. In an exemplary embodiment, dual spurline filter 450 has similar behavior characteristics as single spurline filter 400. Specifically, adding capacitive elements to dual spurline filter 450 enables designing a spurline filter that still has the performance characteristics of a spurline filter but is approximately half the length of a similar spurline filter without capacitive elements added.

For example, the capacitively loaded spurline filter may have a layout area reduction of greater than 25%, greater than 33%, greater than 50% in comparison to a non-capacitive spurline filter of similar performance. Moreover, in an exemplary embodiment, a spurline filter is designed with a through-line length of approximately λ/8, where λ corresponds to a central rejection frequency of the spurline filter. A typical non-capacitively loaded spurline filter will have a through-line length of about λ/4. The capacitive element connected to the spur and either the ground or through-line enables the reduction of through-line length.

Principles of the present disclosure may also suitably be combined with principles for a capacitively loaded spurline filter as disclosed in co-pending U.S. patent application Ser. No. 12/613,724, entitled “Capacitively Loaded Spurline Filter,” filed on Nov. 6, 2009, the contents of which are hereby incorporated by reference in their entirety.

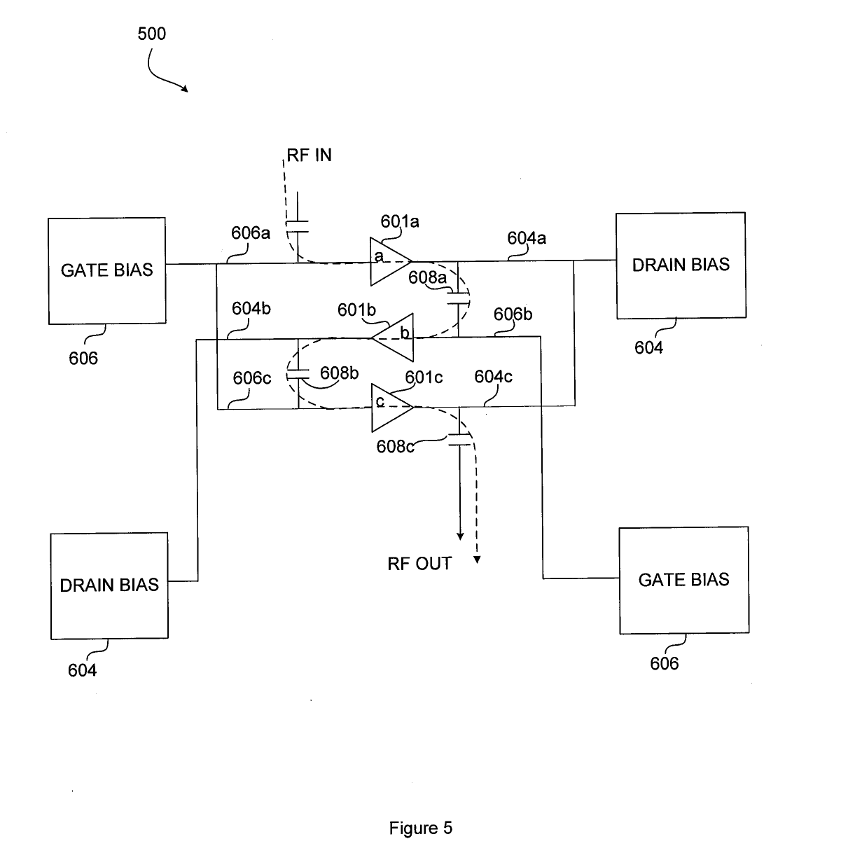

In one exemplary embodiment with reference to FIG. 5, though any driver amplifier(s) may be utilized, the amplifiers of system 200 may comprise MMIC driver amplifier 500. A MMIC driver amplifier may include any number of stages of amplification. For instance, in one embodiment, MMIC driver amplifier 500 includes three stages of amplification 601a-601c which may include FETs, HBTs, or any other suitable active device for the frequency of operation (the active devices are not shown in the present Figure). It should be appreciated that the number of stages, as well as the number of FETs making up each stage can vary depending upon the power drive needed for a particular application.

The unique zig-zag signal flow through the amplification stages of amplifier 500 is represented on FIG. 5 with a dashed line. Although not explicitly identified in FIG. 5, each amplification stage of amplifier 500 includes a suitable RF signal input and output. In operation, a RF signal is supplied to the input of the first stage of amplification, 601a, and then routed from 601a to second stage 601b, and so on, until the RF signal has passed through the last amplification stage (which is stage 601c on FIG. 5). Due to the placement of the stages in relation to each other, the RF signal flow appears as a zig-zag or S-shaped winding pattern through the amplifier. In this manner, the present embodiment configures adjacent stages in a “stacked” configuration. Stated another way, in an exemplary embodiment, the output of one stage is in close proximity to the input of the next stage. It should be appreciated that various other configurations may also be used to cause a similar zig-zag signal flow.

In one exemplary embodiment, MMIC driver amplifier 500 further includes DC bias circuitry 604 and 606, the structure and operation of which are well known and therefore will not be discussed herein. The configuration of the amplification stages allows the bias circuitry to be located in an organized manner away from the stages. For example, bias circuitry 604, 606 may be suitably located on the perimeter of the chip with transmission lines leading to the stages. The placement of the DC components and circuitry in relation to the RF components, as well as on the chip, may offer several advantages such as, DC and RF signal separation, bias may be easily supplied to the perimeter of the chip, and the grouping of DC components may minimize the number of needed components and circuitry.

Leading from bias circuitry 604 and 606 are trace lines to each of the amplification stages. Each stage receives gate bias and drain bias (or the equivalent if FETs are not used) from gate bias circuitry 606 and drain bias circuitry 604, respectively. The present embodiment includes three stages, 601a-601c and, therefore, includes a gate bias feed 606a-606c and drain bias feed 604a-604c for each stage. Additionally, a capacitor 608a-608c may be placed between each of the stages. Capacitors 608a-608c may be configured to, among other functions, provide DC blocking.

As already mentioned, on-chip placement of the RF and DC components in accordance with the invention, helps to reduce the overall size of the chip. Additionally, the interstage matching network of the invention helps to further reduce the number of needed components and reduce the size of the chip. In some exemplary embodiments, a three element matching network may permit impedance matching between the stages without requiring additional elements. For example, drain bias feed 604a may be suitably tuned to be a shunt RF tuning element capacitance 608a may be tuned to be a series capacitance, and gate bias feed 606b may be tuned to be a shunt RF tuning element. In this manner, adjustment to the “already in place” components and/or transmission lines enables interstage matching without sacrificing valuable chip space or amplifier performance. Those of skill in the industry are generally familiar with the various techniques for signal matching (e.g., determining specific component values and the computation involved) and, therefore these techniques will not be discussed herein.

As previously mentioned, it should be appreciated that the number of amplification stages and/or number of FET fingers in each stage can vary depending upon the power needs of the particular application. Additional features of the present embodiment and in accordance with the invention include sharing vias between some or all of the stages. For example, due in part to the stacked configuration of the stages as previously described, the source vias of each stage may be combined. One skilled in the industry can readily recognize that by combining vias, the number of needed vias can be reduced. Hence, using the topology of the invention, the number of vias may be reduced by about 50%, helping to reduce the overall chip size and to maintain the chip integrity.

Principles of the present disclosure may also suitably be combined with principles for RF signal amplification and in particular, to a MMIC driver amplifier as disclosed in U.S. Pat. No. 6,664,855, entitled “MMIC Driver Amplifier Having ZIG-ZAG RF Signal Flow,” filed on Apr. 8, 2002, the contents of which are hereby incorporated by reference in their entirety.

In one exemplary embodiment, system 200 may provide improved frequency isolation. For instance, it may be advantageous to have a high amount of RF gain and overhead after the mixer to prevent early compression. In one exemplary embodiment, the RF gain of the PA after the mixer is configured so that the mixer does not compress. System 200 has a reduced potential for feedback oscillation. Also, the feedback oscillation is lowered in system 200 as compared to non-monolothic systems as the elements are grouped closer together.

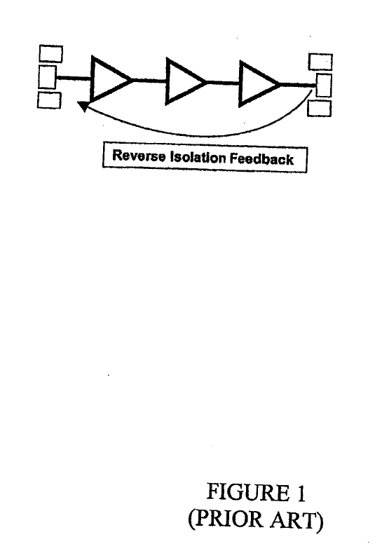

Wirebonds and/or ribbon-bonds (i.e. radiating interfaces) are a main contributor to feedback signal oscillation problems. For instance, with renewed reference to FIG. 1, conventional systems with stand alone chips experience isolation feedback when the input and the output are at the same frequency of the stand alone chips (i.e. the RF-amplifier, or IF-amplifier, and/or LO-amplifier). These stand alone chips have wirebonds/ribbon-bonds at the same frequency, in and out. In one exemplary embodiment, integrating all components on-chip as a system reduces or eliminates wirebond and/or ribbon-bond interface crosstalk. In one exemplary embodiment, the frequency of signals input to system 200 are not at the same frequency as signals output from system 200. In one exemplary embodiment, gain is kept near 40 dB or lower. In one exemplary embodiment, no channelizing or shielding and/or using frequency absorbing materials are used in system 200.

In one embodiment, system 200 may be configured with an on-chip filter network in-line with RF high power amplifier 251. This on-chip filter network may filter out-of-band signals as well as use physically separated IF, LO, and/or RF bondpads. The IF, LO, and/or RF bondpads may be frequency selective. In one exemplary embodiment, MMIC 100 may include frequency selective IF, LO, and/or RF bondpads which may significantly reduce the chance of reverse isolation feedback oscillation. Also, frequency selective bondpads may reduce the potential for on-chip reverse isolation feedback. For instance, the fields may be concentrated in the MMIC 100 substrate rather than having the chance to radiate due to additional circuit discontinuities (e.g. wirebond-to-wirebond).

In one exemplary embodiment, system 200 comprises a high linearity mixer on-chip, such as previously described MMIC based FET resistive mixer 300 and a high power amplifier, such as high power amplifier 251 (HPA) on (the same) chip with substantially lower gain (such as less than 40 dB) than a conventional system can withstand. For instance, a conventional system architecture operated in the same frequency range would result in a high RF gain with increased potential for oscillations.

In one exemplary embodiment, system 200 may include on-chip output power detection. On-chip output power detection may be supplied for external system level optimization. For instance, on-chip output power detection may limit MMIC 100 power amplifier 251 saturation. Also, on-chip output power detection may increase reliability of system 200. Though any power detector may be utilized, power detection may be provided by RF power detector 701 integrally coupled to MMIC 100.

In one exemplary embodiment, the overall gain of system 200 may be optimized. In one exemplary embodiment, system 200 may include an on-chip gain temperature compensation control (e.g. a diode bank). This on-chip gain temperature compensation control may improve gain stability over a wide temperature range. The on-chip gain temperature compensation control may be tailored to control gain stages that do not experience compression in the IF and/or RF chain.

In one embodiment, the single system-on-chip up-converter system 200 includes at least one of: a microprocessor, a memory block, a timing source, a power management circuit, an external interface, a peripheral, a power source, and/or an analog interface. In one embodiment, the single system-on-chip up-converter does not comprise a system-in-package architecture.

In one exemplary embodiment, single system-on-chip up-converter system 200 may combine a local oscillator signal with an intermediate frequency signal in high linear mixer 221. In one exemplary embodiment, mixer 221 outputs a signal to a first driver amplifier. In one exemplary embodiment, the output of mixer 221 is amplified by a first driver amplifier. In one exemplary embodiment, the output of the first driver amplifier is filtered by a filter 241. In one exemplary embodiment, the signal of filter 241 is amplified and output to a second driver amplifier. In one exemplary embodiment, the output of a second driver amplifier is amplified and output to high powered amplifier 251. In an exemplary embodiment, system 200 may operate at a frequency in one of the X, K, Ka, or Ku bands. In an exemplary embodiment, system 200 operates at IF near X band, such as about 7 GHz to about 9 GHz, LO near K-band, such as between about 18 GHz to about 26.5 GHz, and RF near Ka-band about 28 GHz to 30 GHz. In an exemplary embodiment, system 200 may be configured to operate at high micro-wave and millimeter wave frequencies.

By combining elements into a single system-on-chip solution, the cost and complexity of the overall system may be lowered. This may lead to smaller package assembly (i.e. fewer chips). Fewer chips (i.e. 1 vs. 2 or more) leads to a smaller overall package size and/or footprint. Also, fewer chips simplify package assembly. This also leads to fewer chip-to-chip interfaces that may be process sensitive and degrade performance by adding VSWR ripple. System 200 also provides frequency separation between input and output bondpads to reduce gain feedback that can cause oscillations. For example, in one exemplary embodiment the IF bond-pad is at the X-band, the LO bond-pad is at the K-band, and the RF bond-pad is at the Ka-band.

Additionally, system 200 may be designed at any suitable foundry that meets the system performance objectives. Also, system 200 makes use of an on-chip bondpad sensor which can be programmed externally for multiple selections. For instance, these multiple selections may include short circuit, open circuit, and/or resistor ladder networks. In one exemplary embodiment, the external supply voltage and current bias may be optimized to accommodate multiple foundry sources of equivalent MMIC designs simultaneously. In one exemplary embodiment, system 200 includes an on-chip bondpad sensor coupled to a microcontroller or other suitable external device.

In one exemplary embodiment, system 200, due to the highly linear mixer 221 comprises a reduced gain after the mixer. In one exemplary embodiment, the RF gain of the high powered output amplifier 251 is configured so that the high-linear mixer 221 does not compress. In one exemplary embodiment, the RF gain after the high linear mixer is less than 40 dB. In one exemplary embodiment, system 200 maintains spurious signal compliance. In one exemplary embodiment, the elimination of chip-to-chip interfaces in system 200 results in elimination of mismatch issues and reduces standing wave ripple. For instance, in one exemplary embodiment, the elimination of chip-to-chip interfaces in system 200 results in reduction of unwanted ripple.

Due to the compact nature of the topology of system 200 components, the system results in a small footprint on a single chip. For instance, the chip may be less than about 20 square mm. Smaller die area decreases the probability of random die defects within the die itself and reduces the chance of solder voids in the attach process. Moreover, the topology of the invention (e.g., stacked stages and centralized DC circuitry) lends itself to a substantially square chip which helps to improve yields by reducing stress points. In one embodiment an aspect ratio near 1:1 is desirable for wafer post-processing. The relatively thin 2 mil die (i.e. (50 um) is extremely susceptible to breakage, and as the die area increases, the chance of breakage increases. One skilled in the art will readily recognize the benefits of the reduced die size include, but are not limited to, the improved production yield when using a thin die. Some of the advantages of the invention are herein described with respect to a 2 mil die, for among the same and other reasons, it should be appreciated that the present invention is equally as advantageous for other die sizes (e.g., 3-mil, 3.4 mil, 4-mil, 5-mil, and the like). In one exemplary embodiment MMIC 100 has a surface area of less than 16.4 mm² (e.g. 4.3×3.814 mm). In one exemplary embodiment MMIC 100 has a surface area of less than 4.1 mm²/Watt (based on 4 Watts).

In one exemplary embodiment, system 200 may be utilized in a transceiver, receiver and/or transmitter system. In another exemplary embodiment, system 200 may be utilized in a WIN PP15-10 pHEMT. In another exemplary embodiment, in system 200 may be utilized in a TriQuint 0.15 um Power pHEMT (TQP15).

In one exemplary embodiment, elements of system 200 may be optimized at the same time in the same simulation tool environment (i.e., as a single MMIC designed with each piece concurrent on the same process). This helps simplify the design process as well as improves understanding of overall process variations since everything resides on the same chip.)

In one exemplary embodiment, the single system-on-chip up-converter monolithic microwave integrated circuit of system 200 further comprises an on-chip gain temperature compensation control. In this exemplary embodiment, the on-chip gain temperature compensation control comprises a diode bank. In one exemplary embodiment, the single system-on-chip up-converter monolithic microwave integrated circuit of system 200 comprises an on-chip output power detector. In this exemplary embodiment, the on-chip output power detector is a RF-power detector. In one exemplary embodiment the single system-on-chip up-converter monolithic microwave integrated circuit of system 200 does not comprise a system-in-package architecture.

In one exemplary embodiment, the single system-on-chip up-converter monolithic microwave integrated circuit of system 200 further comprises at least one of: a microprocessor; a memory block; a timing source; a power management circuit; an external interface; a peripheral; and an analog interface.

In one exemplary embodiment a method of building a high-linear mixer configured to accept a local oscillator signal and an intermediate frequency signal is disclosed. In this exemplary embodiment, the method includes coupling at least one of a first driver amplifier; a multi-stage filter; a second driver amplifier; a high powered output amplifier together; with no chip-to-chip wirebond interfaces.

It should be appreciated that the particular implementations shown and described herein are illustrative of various embodiments of the invention including its best mode, and are not intended to limit the scope of the present invention in any way. For the sake of brevity, conventional techniques for signal processing, data transmission, signaling, and network control, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical communication system.

While the principles of the invention have now been made clear in illustrative embodiments, there will be immediately obvious to those skilled in the art many modifications of structure, arrangements, proportions, the elements, materials and components, used in the practice of the invention which are particularly adapted for a specific environment and operating requirements without departing from those principles. These and other changes or modifications are intended to be included within the scope of the present invention, as expressed in the following claims.

1. A system comprising:
a high-linear mixer, wherein the high-linear mixer is configured to accept a local oscillator signal and an intermediate frequency signal;
a first driver amplifier;
a multi-stage filter;
a second driver amplifier; and
a high powered output amplifier,
wherein the high-linear mixer, first driver amplifier, multi-stage filter, second driver amplifier, and high powered output amplifier further comprise a single system-on-chip up-converter monolithic microwave integrated circuit.

2. The system of claim 1, wherein a RF gain of the high powered output amplifier is configured so that the high-linear mixer does not compress.

3. The system of claim 1, wherein the RF gain after the high-linear mixer is less than 40 dB.

4. The system of claim 1, wherein the high-linear mixer further comprises:
a microwave monolithic integrated circuit based field effect transistor quad ring mixer, wherein the quad ring mixer comprises four field effect transistors, wherein the quad ring mixer comprises 3 or less total interconnect line lengths from the four field effect transistors.

5. The system of claim 1, wherein the multi-stage filter further comprises a spurline filter.

6. The system of claim 5, wherein the spurline filter comprises:
at least one through-line of the spurline filter;
a spur connected to the at least one through-line; and
a first capacitive element in communication with the spur;
wherein the first capacitive element is connected to at least one of ground or the at least one through-line.

7. The system of claim 1, wherein the single system-on-chip up-converter monolithic microwave integrated circuit further comprises a chip select sensor.

8. The system of claim 1, wherein the surface area of the single system up-converter monolithic microwave integrated circuit is less than 16.4 mm²/watt.

9. The system of claim 1, wherein the single system-on-chip up-converter monolithic microwave integrated circuit further comprises an on-chip bond pad sensor.

10. The system of claim 9, wherein the single system on-chip bond pad sensor is configured to accept programming from an external source.

11. The system of claim 1, wherein the single system-on-chip up-converter monolithic microwave integrated circuit further comprises a filter network in-line with a RF amplifier.

12. The system of claim 1, wherein the system operates at a frequency in one of the X, K, Ka, Ku, V, Q, U, E, F, D, or W bands.

13. The system of claim 1, wherein the single system-on-chip up-converter monolithic microwave integrated circuit further comprises:
a IF bond pad;
a LO bond pad; and
a RF bond pad;
wherein the IF bond pad, LO bond pad, and RF bond pad are frequency selective and physically separated from each other.

14. The system of claim 1, wherein the single system-on-chip up-converter monolithic microwave integrated circuit comprises one of a 2-mil, a 3.4-mil, a 4-mil, or a 5-mil die.

15. The system of claim 1, wherein the monolithic microwave integrated circuit comprises semiconductor material selected from the group of gallium arsenide, indium phosphate, and silicon.

16. A method comprising:
combining a local oscillator signal with an intermediate frequency signal in a high-linear mixer;
outputting a first signal from the high-linear mixer to a first driver amplifier;
amplifying the output of the high-linear mixer;
filtering the output of the first driver amplifier, wherein the filtering is performed by a filter;
outputting a second signal from the filter to a second driver amplifier;
amplifying the output of the filter;
outputting a third signal from the second driver amplifier to a high powered output amplifier; and
amplifying the third signal from the second driver amplifier;
wherein the high-linear mixer, first driver amplifier, multi-stage filter, second driver amplifier, and high powered output amplifier further comprise a single system-on-chip up-converter monolithic microwave integrated circuit.

17. The method of claim 16, wherein the output of the circuit is optimized;
wherein the optimization is realized by optimizing one or more of:
the high-linear mixer, the first driver amplifier; the multi-stage filter;
and the second driver amplifier, in relation to the output of the circuit.

18. The method of claim 16, wherein a RF gain of the high powered output amplifier is configured so that the high-linear mixer does not compress.

19. A system comprising:
a high-linear mixer, wherein the high-linear mixer is configured to accept a local oscillator signal and an intermediate frequency signal;
a first driver amplifier;
a multi-stage filter;
a second driver amplifier; and
a high powered output amplifier,
wherein there is no wirebond between one or more of:
the high-linear mixer,
the first driver amplifier;
the multi-stage filter;
the second driver amplifier; and
the high powered output amplifier.

20. The system of claim 19, wherein a RF gain of the high powered output amplifier is configured so that the high-linear mixer does not compress.
